(19) United States
(12) Patent Application Publication
(10) Pub. No.: US 2011/0090310 A1
(43) Pub. Date: Apr. 21, 2011

(54) METHOD AND APPARATUS FOR REPRODUCING ADAPTIVE MOTION EFFECT USING SCHEMA STRUCTURE INDICATING INFORMATION ASSOCIATED WITH PERFORMANCE OF MOTION DEVICE

(76) Inventors: Eun Seo LEE, Seo-gu (KR); Bum Suk CHOI, Yuseong-gu (KR); Jong Hyun JANG, Yuseong-gu (KR)

(21) Appl. No.: 12/907,654

(22) Filed: Oct. 19, 2010

Related U.S. Application Data
(60) Provisional application No. 61/252,781, filed on Oct. 19, 2009.

(30) Foreign Application Priority Data
Oct. 13, 2010 (KR) 10-2010-0099658

(51) Int. Cl. H04N 13/00; H04N 9/74; H04N 9/475

(52) U.S. Cl. 348/43; 348/578; 348/512; 348/E09.055; 348/E09.034; 348/E13.001

(57) ABSTRACT

Provided is an apparatus for reproducing an adaptive motion effect, including: a media processing module to separate, from multimedia content comprising information associated with a motion effect applied to each scene of content, information associated with the motion effect; a motion effect adaptation module to convert information associated with the motion effect to adaptive control information acceptable by a motion apparatus reproducing the motion effect, based on a metadata schema indicating information associated with a capability of the motion apparatus; and an apparatus control module to generate a signal for controlling the motion apparatus based on the adaptive control information.

### CROSS-REFERENCE TO RELATED APPLICATION

This application claims the benefit under 35 U.S.C. §119(e) of a U.S. Provisional Patent Application No. 61/252,781, filed on Oct. 19, 2009, in the U.S. Patent and Trade Mark Office, and the benefit under 35 U.S.C. §119(a) of a Korean Patent Application No. 10-2010-0099658, filed on Oct. 13, 2010, in the Korean Intellectual Property Office, the entire disclosures of which are incorporated herein by reference for all purposes.

### BACKGROUND OF THE INVENTION

1. Field of the Invention

The following embodiments of the present invention relate to an apparatus and method for reproducing an adaptive motion effect using a schema structure indicating information associated with a capability of a motion apparatus for reproducing a motion effect.

2. Description of the Conventional Art

Users' desire for more realistic contents consumption has created a three-dimensional (3D) video and 3D audio system. The introduction of a motion chair has enabled the users to experience, using their whole body, a multimedia service that used to be enjoyable using only eyes and ears.

Using a single media multi-device (SMMD) technology, a sensory effect reproducing system may insert, into content, information for controlling a motion apparatus such as a motion chair through a variety of creation tools, and may synchronize the content and a control signal in a home server to thereby control the motion apparatus.

In addition, using the SMMD technology, the sensory effect reproducing system may insert information associated with a motion effect into the content and thereby control the motion apparatus.

However, when a signal indicating a motion effect unacceptable by the motion apparatus is transferred, the motion apparatus may not reproduce the transferred motion effect. Accordingly, there is a desire for a method and apparatus that enables all the motion apparatuses to reproduce a motion effect described by a creator within the range that can be reproduced by a corresponding motion apparatus. In addition, there is a need to define a schema structure for expressing the motion effect.

### SUMMARY OF THE INVENTION

An aspect of the present invention provides a method and apparatus for reproducing an adaptive motion effect that may provide a structure of a metadata schema indicating information associated with a capability of a motion apparatus reproducing a motion effect.

Another aspect of the present invention also provides a method and apparatus for reproducing an adaptive motion effect that may convert a motion effect intended by a creator to adaptive control information acceptable by a motion apparatus reproducing a motion effect associated with a multimedia service, with respect to the motion apparatus.

According to an aspect of the present invention, there is provided an apparatus for reproducing an adaptive motion effect, including: a media processing module to separate, from multimedia content including information associated with a motion effect applied to each scene of content, information associated with the motion effect; a motion effect adaptation module to convert information associated with the motion effect to adaptive control information acceptable by a motion apparatus reproducing the motion effect, based on a metadata schema indicating information associated with a capability of the motion apparatus; and an apparatus control module to generate a signal for controlling the motion apparatus based on the adaptive control information.

According to another aspect of the present invention, there is provided a method of reproducing an adaptive motion effect, including: maintaining a metadata schema indicating information associated with a capability of a motion apparatus; separating, from multimedia content including information associated with a motion effect applied to each scene of content, information associated with the motion effect; analyzing whether the motion apparatus includes a function for configuring information associated with the motion effect, based on the metadata schema; converting information associated with the motion effect to adaptive control information acceptable by the motion apparatus, depending on whether the motion apparatus includes the function for configuring information associated with the motion effect; and generating a signal for controlling the motion apparatus based on the adaptive control information.

According to embodiments of the present invention, it is possible to adaptively convert information associated with a motion effect for each of various motion apparatus by defining a metadata schema indicating information associated with a capability of a corresponding motion apparatus reproducing the motion effect.

Also, according to embodiments of the present invention, each of motion apparatuses having different capabilities may reproduce an optimal motion effect by converting information associated with a motion effect to adaptive control information acceptable by a corresponding motion apparatus.

### BRIEF DESCRIPTION OF THE DRAWING

FIG. 1 is a diagram illustrating an apparatus for reproducing an adaptive motion effect using a schema structure indicating information associated with a capability of a motion apparatus according to an embodiment of the present invention; and

FIG. 2 is a flowchart illustrating a method of reproducing an adaptive motion effect using a schema structure indicating information associated with a capability of a motion apparatus according to an embodiment of the present invention.

### DETAILED DESCRIPTION OF THE PREFERRED EMBODIMENT

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

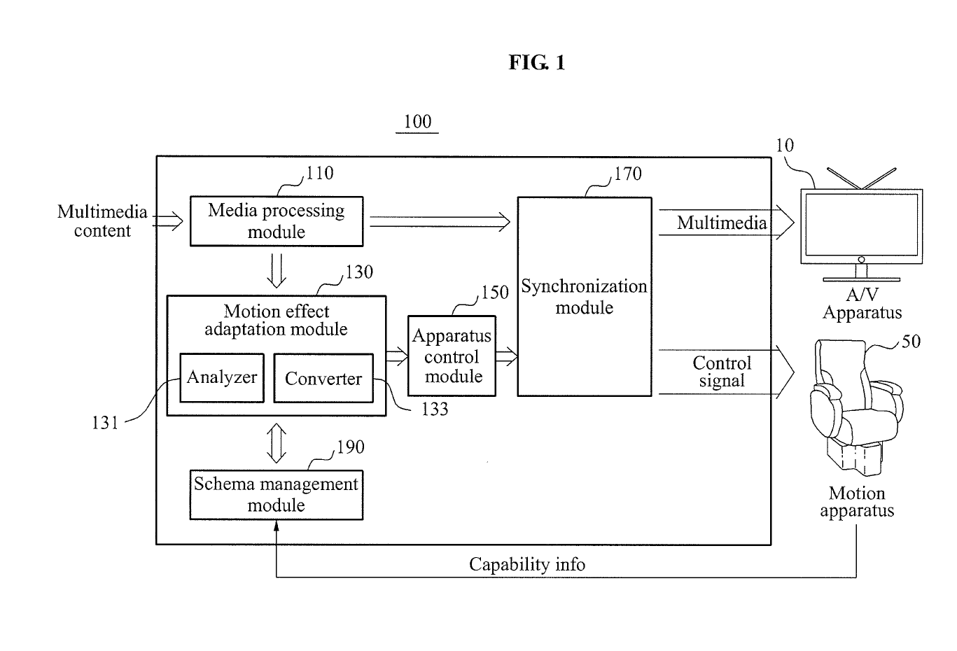

FIG. 1 is a diagram illustrating an apparatus 100 for reproducing an adaptive motion effect using a schema structure indicating information associated with a capability of a motion apparatus according to an embodiment of the present invention.

Referring to FIG. 1, the adaptive motion effect reproducing apparatus 100 may include a media processing module 110, a motion effect adaption module 130, an apparatus control module 150, a synchronization module 170, and a schema management module 190.

As shown in FIG. 1, a multimedia content created by inserting, by a content creator, information associated with a motion effect applied to each scene of content may be input into the adaptive motion effect reproducing apparatus 100.

The adaptive motion effect reproducing apparatus 100 may provide, to an audio and video (A/V) apparatus 10 playing back an audio and video (A/V) signal, a multimedia signal including an A/V signal with respect to each scene of content, and may provide a signal for controlling a motion apparatus 50 reproducing a motion effect. The adaptive motion effect reproducing apparatus 100 may be, for example, a home server.

The media processing module 110 may separate, from the multimedia content including information associated with the applied motion effect, a motion effect signal including information associated with the motion effect, and the A/V signal.

The media processing module 110 may separate the A/V signal from the multimedia content, and may interpret the A/V signal using a media codec. The interpreted A/V signal may be reproduced by the A/V apparatus 10.

The motion apparatus 50 may be controlled by the signal for controlling the motion apparatus 50, and may be, for example, a motion chair, a rowing machine, and the like. The signal for controlling the motion apparatus 50 may be generated by the apparatus control module 150.

When a motion effect that cannot be reproduced by the motion apparatus 50 is input into the motion apparatus 50, the motion apparatus 50 may be suspended without reproducing the motion effect. Similarly, when information associated with a capability of the motion apparatus 50 is not pre-stored, the motion apparatus 50 may also be suspended.

However, when the adaptive motion effect reproducing apparatus 100 is aware of information associated with the capability of the motion apparatus 50 reproducing the motion effect, the adaptive motion effect reproducing apparatus 100 may convert information associated with the motion effect to an optimal value acceptable by the motion apparatus 50 using the motion effect adaptation module 130.

The motion effect adaptation module 130 may convert information associated with the motion effect to adaptive control information acceptable by the motion apparatus 50, based on a metadata schema. The metadata schema indicates information associated with the capability of the motion apparatus 50 reproducing the motion effect.

Information associated with the capability of the motion apparatus 50 may have a schema structure that is defined according to a motion pattern based on 6 degrees of freedom (DoF).

The motion effect adaptation module 130 may include an analyzer 131 and a converter 133.

The analyzer 131 may analyze whether the motion apparatus 50 includes a function for configuring information associated with the motion effect, based on the metadata schema.

When the motion apparatus 50 does not include the function for configuring information associated with the motion effect, the converter 133 may convert information associated with the motion effect to the adaptive control information acceptable by the motion apparatus 50.

The apparatus control module 150 may generate the signal for controlling the motion apparatus 50 based on the adaptive control information.

The synchronization module 170 may synchronize the signal for controlling the motion apparatus 50 with the interpreted A/V signal. Through the synchronization, the signal for controlling the motion apparatus 50, and the interpreted A/V signal may be sequentially played.

The schema management module 190 may manage the metadata schema indicating information associated with the capability of the motion apparatus 50.

The schema management module 190 may process and store information associated with the capability of the motion apparatus 50, based on the schema structure that is defined according to a motion pattern based on 6DoF.

With respect to the capability of the motion apparatus 50, the motion pattern may include a move pattern indicating a rotation-free three-dimensional (3D) motion, and an incline pattern indicating a rotating 3D motion including a pitch, a yaw, and a roll.

With respect to the capability of the motion apparatus 50, the move pattern may include at least one move pattern type among a distance, a speed, and an acceleration in each of an X axis, an Y axis, and a Z axis, and a level of the distance, a level of the speed, and a level of the acceleration.

With respect to the capability of the motion apparatus 50, the incline pattern may include at least one incline pattern type among an angle, a speed, and an acceleration with respect to each of the pitch, the yaw, and the roll, and an angle level, a speed level, and an acceleration level with respect to each of the pitch, the yaw, and the roll. A schema structure with respect to each of the move pattern and the incline pattern will be further described.

For example, it may be assumed that the motion apparatus 50 cannot move left and right.

The corresponding motion apparatus 50 may inform the adaptive motion effect reproducing apparatus 100 about information associated with a capability that the motion apparatus 50 cannot move left and right, however, can incline left and right.

Next, based on the schema structure that is defined according to the motion pattern based on 6DOF, the adaptive motion effect reproducing apparatus 100 may process and store information associated with the capability of the motion apparatus 50, for example, information that the motion apparatus 50 cannot move left and right, however, incline left and right.

When a multimedia content including information associated with a motion effect “move left by 5 cm” is input, the motion effect adaptation module 130 may analyze, using the analyzer 131, whether the motion apparatus 50 has a function for configuring the above motion effect information “move left by 5 cm”.

When the motion apparatus 50 does not include the above function, the converter 133 may convert the motion effect information “move left by 5 cm” to adaptive control information acceptable by the motion apparatus 50.

For example, the adaptive control information acceptable by the motion apparatus 50 may correspond to information “incline left by 5 degrees”.

Accordingly, the motion apparatus 50 not having the function of moving left and right may perform an operation of “inclining left by 5 degrees”, and thereby reproduce a similar effect to the motion effect required for a scene of the multimedia content.

A converting method or a mapping method according to each move pattern may be performed using a variety of methods.

As described above, even though an adaptive motion effect reproduction apparatus does not include a function for configuring information associated with an input motion effect, it is possible to reproduce a similar motion effect by converting information associated with the motion effect to optimal adaptive control information that can be reproduced by the adaptive motion effect reproduction apparatus.

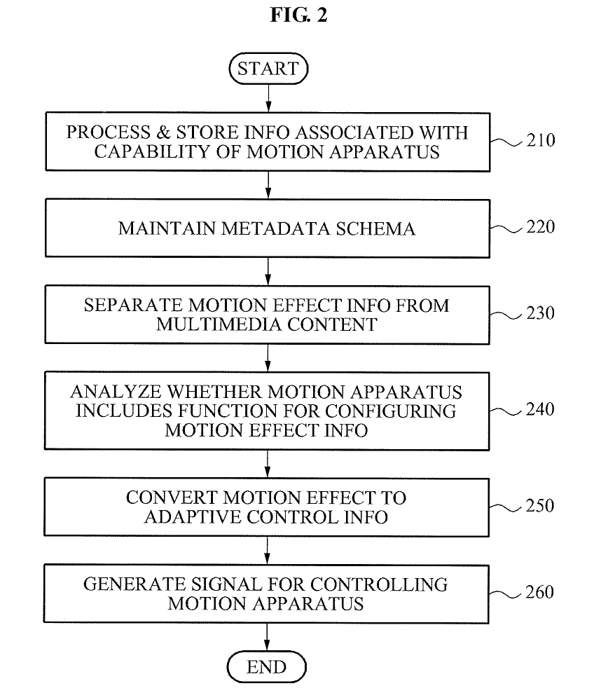

FIG. 2 is a flowchart illustrating a method of reproducing an adaptive motion effect using a schema structure indicating information associated with a capability of a motion apparatus according to an embodiment of the present invention.

Referring to FIG. 2, in operation 210, an adaptive motion effect reproduction apparatus may process and store information associated with a capability of a motion apparatus based on a schema structure that is defined according to a motion pattern based on 6DoF.

In operation 220, the adaptive motion effect reproduction apparatus may maintain a metadata schema indicating information associated with the capability of the motion apparatus.

Information associated with the capability of the motion apparatus may have the schema structure that is defined according to the motion pattern based on 6DoF.

In operation 230, the adaptive motion effect reproduction apparatus may separate, from multimedia content including information associated with a motion effect applied to each scene of content, information associated with the motion effect.

In this instance, the adaptive motion effect reproduction apparatus may separate an A/V signal from the multimedia content, and interpret the A/V signal using a media codec.

In operation 240, the adaptive motion effect reproduction apparatus may analyze whether the motion apparatus includes a function for configuring information associated with the motion effect. Whether the motion apparatus includes the function for configuring information associated with the motion effect may be analyzed based on the metadata schema.

In operation 250, the adaptive motion effect reproduction apparatus may convert information associated with the motion effect to adaptive control information acceptable by the motion apparatus, depending on whether the motion apparatus includes the function for configuring information associated with the motion effect. In operation 260, the adaptive motion effect reproduction apparatus may generate a signal for controlling the motion apparatus based on the adaptive control information.

The adaptive motion effect reproduction apparatus may synchronize the signal for controlling the motion apparatus with the interpreted A/V signal, and may provide a synchronized signal to each of an A/V apparatus and the motion apparatus.

Hereinafter, the schema structure indicating information associated with the capability of the motion apparatus defined according to an embodiment of the present invention will be further described.

### 1. RigidBodyMotion Capability Type

Syntax and semantics of a metadata schema indicating information associated with a capability of a motion apparatus reproducing a motion effect will be described.

### 1.1 Syntax

<!-- ################################################ -->

| | | |
|---|---|---|
| <!-- | Rigid Body Motion capability type | --> |

```
<!-- ################################################ -->
<complexType name=“RigidBodyMotionCapabilityType”>
  <complexContent>
    <extension base=“cidl:SensoryDeviceCapabilityBaseType”>
      <sequence>
```

| | |
|---|---|
| <element | name=“MoveTowardCapability” |

type=“dcdv:MoveTowardCapabilityType” minOccurs=“0”/>

| | |
|---|---|
| <element | name=“InclineCapability” |

```
type=“dcdv:InclineCapabilityType” minOccurs=“0”/>
      </sequence>
    </extension>
  </complexContent>
</complexType>
<!-- ################################################ -->
```

| | |
|---|---|
| <!-- MoveToward Capability type | --> |

```
<!-- ################################################ -->
<complexType name=“MoveTowardCapabilityType”>
  <attribute name=“MaxXDistance” type=“float” use=“optional”/>
  <attribute name=“MaxYDistance” type=“float” use=“optional”/>
  <attribute name=“MaxZDistance” type=“float” use=“optional”/>
  <attribute name=“distanceUnit” type=“mpegvct:unitType” use=“optional”/>
  <attribute name=“MaxXSpeed” type=“float” use=“optional”/>
  <attribute name=“MaxYSpeed” type=“float” use=“optional”/>
  <attribute name=“MaxZSpeed” type=“float” use=“optional”/>
  <attribute name=“speedUnit” type=“mpegvct:unitType” use=“optional”/>
  <attribute name=“MaxXAccel” type=“float” use=“optional”/>
  <attribute name=“MaxYAccel” type=“float” use=“optional”/>
  <attribute name=“MaxZAccel” type=“float” use=“optional”/>
  <attribute name=“accelUnit” type=“mpegvct:unitType” use=“optional”/>
  <attribute name=“XDistanceLevels” type=“nonNegativeInteger” use=“optional”/>
  <attribute name=“YDistanceLevels” type=“nonNegativeInteger” use=“optional”/>
  <attribute name=“ZDistanceLevels” type=“nonNegativeInteger” use=“optional”/>
  <attribute name=“XSpeedLevels” type=“nonNegativeInteger” use=“optional”/>
  <attribute name=“YSpeedLevels” type=“nonNegativeInteger” use=“optional”/>
  <attribute name=“ZSpeedLevels” type=“nonNegativeInteger” use=“optional”/>
  <attribute name=“XAccelLevels” type=“nonNegativeInteger” use=“optional”/>
  <attribute name=“YAccelLevels” type=“nonNegativeInteger” use=“optional”/>
  <attribute name=“ZAccelLevels” type=“nonNegativeInteger” use=“optional”/>
</complexType>
<!-- ################################################ -->
```

| | | |
|---|---|---|
| <!-- | Incline Capability type | --> |

<!-- ################################################ -->
<complexType name=“InclineCapabilityType”>

| | | |
|---|---|---|
| <attribute | name=“MaxPitchAngle” | type=“mpegvct:InclineAngleType” |
| use=“optional”/> | | |
| <attribute | name=“MaxYawAngle” | type=“mpegvct:InclineAngleType” |
| use=“optional”/> | | |
| <attribute | name=“MaxRollAngle” | type=“mpegvct:InclineAngleType” |

```
use=“optional”/>
  <attribute name=“MaxPitchSpeed” type=“float” use=“optional”/>
  <attribute name=“MaxYawSpeed” type=“float” use=“optional”/>
  <attribute name=“MaxRollSpeed” type=“float” use=“optional”/>
  <attribute name=“speedUnit” type=“mpegvct:unitType” use=“optional”/>
  <attribute name=“MaxPitchAccel” type=“float” use=“optional”/>
  <attribute name=“MaxYawAccel” type=“float” use=“optional”/>
  <attribute name=“MaxRollAccel” type=“float” use=“optional”/>
  <attribute name=“accelUnit” type=“mpegvct:unitType” use=“optional”/>
  <attribute name=“PitchAngleLevels” type=“nonNegativeInteger” use=“optional”/>
  <attribute name=“YawAngleLevels” type=“nonNegativeInteger” use=“optional”/>
  <attribute name=“RollAngleLevels” type=“nonNegativeInteger” use=“optional”/>
  <attribute name=“PitchSpeedLevels” type=“nonNegativeInteger” use=“optional”/>
  <attribute name=“YawSpeedLevels” type=“nonNegativeInteger” use=“optional”/>
  <attribute name=“RollSpeedLevels” type=“nonNegativeInteger” use=“optional”/>
  <attribute name=“PitchAccelLevels” type=“nonNegativeInteger” use=“optional”/>
  <attribute name=“YawAccelLevels” type=“nonNegativeInteger” use=“optional”/>
  <attribute name=“RollAccelLevels” type=“nonNegativeInteger” use=“optional”/>
</complexType>
```

### 1.2 Semantics

Types of the metadata schema indicating information associated with the capability of the motion apparatus reproducing the motion effect may include RigidBodyMotionCapabilityType, MoveTowardCapability, and InclineCapability, as shown in Table 1:

TABLE 1

| Name | Definition |
|---|---|
| RigidBodyMotionCapabilityType | Tool for describing the capability of |
| | Rigid body motion effect. |
| MoveTowardCapability | Describes the capability for move |
| | toward motion effect. |
| InclineCapability | Describes the capability for Incline |
| | motion effect. |

Here, RigidBodyMotionCapabilityType is to describe the capability of a rigid body of the motion apparatus with respect to the motion effect.

MoveTowardCapability describes a capability for a move motion effect, and InclineCapability describes a capability for an incline motion effect.

Semantics of a schema structure with respect to MoveTowardCapability is shown in Table 2:

TABLE 2

| Name | Definition |
|---|---|
| MoveTowardCapabilityType | Tool to describe the capability of move motion |
| | effect. |
| MaxXDistance | Maximum movement distance in X axis that can be |
| | provided based on centimeter unit by the motion |
| | apparatus. |
| | EXAMPLE: Value ‘10’ indicates that the motion |
| | apparatus can move maximum of 10 cm in X axis. |
| | NOTE: Value ‘0’ indicates that the motion |
| | apparatus cannot move in X axis. |
| MaxYDistance | Maximum movement distance in Y axis that can be |
| | provided based on centimeter unit by the motion |
| | apparatus. |
| MaxZDistance | Maximum movement distance in Z axis that can be |
| | provided based on centimeter unit by the motion |
| | apparatus. |
| distanceUnit | If other unit excluding centimeter is used, unit is |
| | specified to describe MaxXDistance, |
| | MaxYDistance, and MaxZDistance attributes as |
| | reference with respect to class criterion terms |
| | provided by UnitTypeCS defined in A.2.1 of |
| | ISO/IEC 23005-6. |
| | The above three attributes have the same unit. |
| MaxXSpeed | Maximum speed in X axis that can be provided |
| | based on a unit of cm/sec by the motion apparatus. |
| MaxYSpeed | Maximum speed in Y axis that can be provided |
| | based on a unit of cm/sec by the motion apparatus. |
| MaxZSpeed | Maximum speed in Z axis that can be provided |
| | based on a unit of cm/sec by the motion apparatus. |
| speedUnit | If other unit excluding cm/sec is used, unit is |
| | specified to describe MaxXSpeed, MaxYSpeed, and |
| | MaxZSpeed attributes as reference with respect to |
| | class criterion terminals provided by UnitTypeCS |
| | defined in A.2.1 of ISO/IEC 23005-6. |
| | The above three attributes have the same unit. |
| MaxXAccel | Maximum acceleration in X axis that can be |
| | provided based on a unit of cm/sec² by the motion |
| | apparatus. |
| MaxYAccel | Maximum acceleration in Y axis that can be |
| | provided based on a unit of cm/sec² by the motion |
| | apparatus. |
| MaxZAccel | Maximum acceleration in Z axis that can be |
| | provided based on a unit of cm/sec² by the motion |
| | apparatus. |
| accelUnit | If other unit excluding cm/sec² is used, unit is |
| | specified to describe MaxXAccel, MaxYAccel, and |
| | MaxZAccel attributes as a reference with respect to |
| | class criterion terms provided by UnitTypeCS |
| | defined in A.2.1 of ISO/IEC 23005-6. |
| | The above three attributes have the same unit. |
| XDistancelevels | Number of distance levels that can be provided |
| | between maximum distance and minimum distance |
| | in X axis by the motion apparatus. |
| | EXAMPLE: Value ‘5’ indicates that the motion |
| | apparatus can provide five steps from minimum |
| | distance to maximum distance in X axis. |
| YDistancelevels | Number of distance levels that can be provided |
| | between maximum distance and minimum distance |
| | in Y axis by the motion apparatus. |
| ZDistancelevels | Number of distance levels that can be provided |
| | between maximum distance and minimum distance |
| | in Z axis by the motion apparatus. |
| XSpeedLevels | Number of speed levels that can be provided |
| | between maximum speed and minimum speed in X |
| | axis by the motion apparatus. |
| YSpeedLevels | Number of speed levels that can be provided |
| | between maximum speed and minimum speed in Y |
| | axis by the motion apparatus. |
| ZSpeedLevels | Number of speed levels that can be provided |
| | between maximum speed and minimum speed in Z |
| | axis by the motion apparatus. |
| XAccelLevels | Number of acceleration levels that can be provided |
| | between maximum acceleration and minimum |
| | acceleration in X axis by the motion apparatus. |
| YAccelLevels | Number of acceleration levels that can be provided |
| | between maximum acceleration and minimum |
| | acceleration in Y axis by the motion apparatus. |
| ZAccelLevels | Number of acceleration levels that can be provided |
| | between maximum acceleration and minimum |
| | acceleration in Z axis by the motion apparatus. |

For example, it is assumed that the motion apparatus has MoveTowardCapability where a maximum movement in each of the X and Y axes is 20 cm, a maximum speed in each of the X and Y axes is 10 cm/s, a maximum speed in the Z axis is 0 cm/s, a maximum acceleration in each of the X and Y axes is 1 cm/s², and a maximum acceleration in the Z axis is 0 cm/s². That is, the motion apparatus cannot move in the Z axis. Also, it is assumed that XSpeedLevels and XAccelLevels of the motion apparatus are respectively ‘10’ and ‘5’, and YSpeedLevels and YAccelLevels of the motion apparatus are ‘5’.

In this example, the schema structure with respect to MoveTowardCapability of the corresponding motion apparatus may be described as follows:

| <dcdv:MoveTowardCapability | | xsi:type=“dcdv:MoveTowardCapabilityType” | |
|---|---|---|---|
| MaxXAccel=“1” | MaxXSpeed=“10” | MaxXDistance=“20” | MaxYAccel=“1” |
| MaxYSpeed=“10” | MaxYDistance=“20” | MaxZAccel=“0” | MaxZSpeed=“0” |
| MaxZDistance=“0” | XAccelLevels=“5” | XDistanceLevels=“20” | XSpeedLevels=“10” |
| YAccelLevels=“5” | YDistanceLevels=“20” | YSpeedLevels=“20” | ZAccelLevels=“0” |

ZDistanceLevels=“0” ZSpeedLevels=“0”/>

Semantics of the schema structure with respect to InclineCapability may be expressed by Table 3:

TABLE 3

| Name | Definition |
|---|---|
| InclineCapabilityType | Tool to describe the capability of incline effect of motion apparatus. |
| MaxPitchAngle | Maximum rotation angle in X axis that can be provided based on a |
| | degree unit by the motion apparatus. |
| | NOTE: Rotation angle increase counterclockwise. |
| MaxYawAngle | Maximum rotation angle in Y axis that can be provided based on a |
| | degree unit by the motion apparatus. |
| | NOTE: Rotation angle increases clockwise. |
| MaxRollAngle | Maximum rotation angle in Z axis that can be provided based on a |
| | degree unit by the motion apparatus. |
| | NOTE: Rotation angle increase counterclockwise. |
| MaxPitchSpeed | Maximum rotation speed in X axis that can be provided based on a |
| | unit of degree/second by the motion apparatus. |
| MaxYawSpeed | Maximum rotation speed in Y axis that can be provided based on a |
| | unit of degree/second by the motion apparatus. |
| MaxRollSpeed | Maximum rotation speed in Z axis that can be provided based on a |
| | unit of degree/second by the motion apparatus. |
| speedUnit | If other unit excluding degree/second is used, common unit is |
| | specified to describe to MaxPitchSpeed, MaxYawSpeed, and |
| | MaxRollSpeed attributes as reference with respect to class criterion |
| | terms provided by UnitTypeCS defined in A.2.1 of ISO/IEC 23005-6. |
| MaxPitchAccel | Maximum rotation acceleration in X axis that can be provided based |
| | on a unit of degree/second² by the motion apparatus. |
| MaxYawAccel | Maximum rotation acceleration in Y axis that can be provided based |
| | on a unit of degree/second² by the motion apparatus. |
| MaxRollAccel | Maximum rotation acceleration in Z axis that can be provided based |
| | on a unit of degree/second² by the motion apparatus. |
| accelUnit | If other unit excluding degree/second² is used, a common unit is |
| | specified to describe MaxPitchAccel, MaxYawAccel, and |
| | MaxRollAccel attributes as reference with respect to class criterion |
| | terms provided by UnitTypeCS defined in A.2.1 of ISO/IEC 23005-6. |
| PitchAngleLevels | Number of rotation angle levels that can be provided between |
| | minimum angle and maximum angle in X axis by the motion apparatus. |
| | EXAMPLE: Value ‘5’ indicates that the motion apparatus can provide |
| | five steps between minimum angle and maximum angle in X axis. |
| YawAngleLevels | Number of rotation angle levels that can be provided between |
| | minimum angle and maximum angle in Y axis by the motion apparatus. |
| RollAngleLevels | Number of rotation angle levels that can be provided between |
| | minimum angle and maximum angle in Z axis by the motion apparatus. |
| PitchSpeedLevels | Number of rotation speed levels that can be provided between |
| | minimum speed and maximum speed in X axis by the motion apparatus. |
| | EXAMPLE: Value ‘5’ indicates that the motion apparatus can provide |
| | five steps between minimum speed and maximum speed in X axis. |
| YawSpeedLevels | Number of rotation speed levels that can be provided between |
| | minimum speed and maximum speed in Y axis by the motion apparatus. |
| RollSpeedLevels | Number of rotation speed levels that can be provided between |
| | minimum speed and maximum speed in Z axis by the motion apparatus. |
| PitchAccelLevels | Number of rotation acceleration levels that can be provided between |
| | minimum acceleration and maximum acceleration in X axis by the |
| | motion apparatus. |
| YawAccelLevels | Number of rotation acceleration levels that can be provided between |
| | minimum acceleration and maximum acceleration in Y axis by the |
| | motion apparatus. |
| RollAccelLevels | Number of rotation acceleration levels that can be provided between |
| | minimum acceleration and maximum acceleration in Z axis by the |
| | motion apparatus. |

For example, it is assumed that the motion apparatus has InclineCapability where the motion apparatus can rotate 180 degrees in the X axis and 90 degrees in the Y axis, and a maximum angle speed in each of the X and Y axes is 10°/s, a maximum angle speed in the Z axis is 0°/s, a maximum rotation acceleration in each of the X and Y axes is 2°/s², and a maximum rotation acceleration in the Z axis is 0°/s². That is, the corresponding motion apparatus cannot move in the Z axis. Also, it is assumed that PitchSpeedLevels and PitchAccelLevels of the motion apparatus are ‘1’, and YawSpeedLevels and YawAccelLevels of the motion apparatus is ‘1’.

In this example, the schema structure with respect to InclineCapability of the corresponding motion apparatus may be described as follows:

| | |
|---|---|
| <dcdv:InclineCapability | xsi:type=“dcdv:InclineCapabilityType” |

| | | |
|---|---|---|
| MaxXRotationAccel=“2” | MaxXRotationAngle=“180” | MaxXRotationSpeed=“10” |
| MaxYRotationAccel=“2” | MaxYRotationAngle=“90” | MaxYRotationSpeed=“10” |
| MaxZRotationAccel=“0” | MaxZRotationAngle=“0” | MaxZRotationSpeed=“0” |
| XRotationAccelLevels=“1” | XRotationAngleLevels=“1” | XRotationSpeedLevels=“1” |
| YRotationAccelLevels=“1” | YRotationAngleLevels=“1” | YRotationSpeedLevels=“1” |

ZRotationAccelLevels=“0” ZRotationAngleLevels=“0” ZRotationSpeedLevels=“0”/>

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for reproducing an adaptive motion effect, comprising:
a media processing module to separate, from multimedia content comprising information associated with a motion effect applied to each scene of content, information associated with the motion effect;
a motion effect adaptation module to convert information associated with the motion effect to adaptive control information acceptable by a motion apparatus reproducing the motion effect, based on a metadata schema indicating information associated with a capability of the motion apparatus; and
an apparatus control module to generate a signal for controlling the motion apparatus based on the adaptive control information.

2. The apparatus of claim 1, wherein the motion effect adaptation module comprises:
an analyzer to analyze whether the motion apparatus includes a function for configuring information associated with the motion effect, based on the metadata schema; and
a converter to convert information associated with the motion effect to the adaptive control information acceptable by the motion apparatus when the motion apparatus does not include the function for configuring information associated with the motion effect.

3. The apparatus of claim 1, wherein the media processing module separates an audio and video (A/V) signal from the multimedia content, and interprets the A/V signal using a media codec.

4. The apparatus of claim 3, further comprising:
a synchronization module to synchronize a signal for controlling the motion apparatus with the interpreted A/V signal.

5. The apparatus of claim 1, further comprising:
a schema management module to manage the metadata schema indicating information associated with the capability of the motion apparatus.

6. The apparatus of claim 5, wherein the schema management module processes and stores information associated with the capability of the motion apparatus based on a schema structure that is defined according to a motion pattern based on 6 degrees of freedom (DoF).

7. The apparatus of claim 1, wherein information associated with the capability of the motion apparatus has a schema structure that is defined according to a motion pattern based on 6DoF.

8. The apparatus of claim 7, wherein, with respect to the capability of the motion apparatus, the motion pattern comprises a move pattern indicating a rotation-free three-dimensional (3D) motion, and an incline pattern indicating a rotating 3D motion comprising a pitch, a yaw, and a roll.

9. The apparatus of claim 8, wherein, with respect to the capability of the motion apparatus, the move pattern comprises at least one move pattern type among a distance, a speed, and an acceleration in each of an X axis, an Y axis, and a Z axis, and a level of the distance, a level of the speed, and a level of the acceleration.

10. The apparatus of claim 8, wherein, with respect to the capability of the motion apparatus, the incline pattern comprises at least one incline pattern type among an angle, a speed, and an acceleration with respect to each of the pitch, the yaw, and the roll, and an angle level, a speed level, and an acceleration level with respect to each of the pitch, the yaw, and the roll.

11. A method of reproducing an adaptive motion effect, comprising:
maintaining a metadata schema indicating information associated with a capability of a motion apparatus;
separating, from multimedia content comprising information associated with a motion effect applied to each scene of content, information associated with the motion effect;
analyzing whether the motion apparatus includes a function for configuring information associated with the motion effect, based on the metadata schema;
converting information associated with the motion effect to adaptive control information acceptable by the motion apparatus, depending on whether the motion apparatus includes the function for configuring information associated with the motion effect; and
generating a signal for controlling the motion apparatus based on the adaptive control information.

12. The method of claim 11, wherein the separating comprises:
separating an audio and video (A/V) signal from the multimedia content; and
interpreting the A/V signal using a media codec.

13. The method of claim 12, further comprising:
synchronizing the signal for controlling the motion apparatus with the interpreted A/V signal.

14. The method of claim 11, wherein the maintaining comprises processing and storing information associated with the capability of the motion apparatus based on a schema structure that is defined according to a motion pattern based on 6 degrees of freedom (DoF).

15. The method of claim 11, wherein information associated with the capability of the motion apparatus has a schema structure that is defined according to a motion pattern based on 6DoF.
